(19) United States
(12) Patent Application Publication
(10) Pub. No.: US 2022/0337484 A1
(43) Pub. Date: Oct. 20, 2022

(54) CENTRAL CONTROLLER FOR A DATA NETWORK

(71) Applicant: TURCK Holding GmbH, Halver (DE)

(72) Inventor: Peter Strunkmann, Detmold (DE)

(21) Appl. No.: 17/719,402

(22) Filed: Apr. 13, 2022

(30) Foreign Application Priority Data
Apr. 15, 2021 (DE) 10 2021 109 418.6

(51) Int. Cl. H04L 41/12; G08B 7/06

(52) U.S. Cl. CPC H04L 41/12; G08B 7/06

(57) ABSTRACT

A central controller for a data network includes an input interface for receiving a request signal, a control unit for generating a control signal depending on the request signal received, and at least one output interface for transmitting the control signal to at least one participant device. The control signal is set up to actuate the at least one participant device to emit a participant output signal for identifying a physical position of the at least one participant device.

### CROSS-REFERENCE TO PRIOR APPLICATIONS

This application claims benefit to German Patent Application No. DE 10 2021 109 418.6, filed on Apr. 15, 2022, which is hereby incorporated by reference herein.

### FIELD

The invention relates to a central controller for a data network, a system for a data network, as well as a method for operating a central controller in a data network.

### BACKGROUND

In complex networks, many actuators and sensors as well as control and monitoring devices are often linked to each other and positioned in different locations. During troubleshooting, for maintenance or for other purposes, particular devices occasionally need to be physically found. However, this can cause substantial difficulties precisely in the case of a standardized appearance of the devices, as they are not readily recognizable by their outsides.

From DE 10 2018 118 872, a method for checking the data transfer of an electrical switchgear is known, in which light-emitting diode (LED) generates a light signal, which is perceived by the observer as constant light, but by means of which an optical reader can detect user data.

Methods are known in which a device can be requested to indicate its position by flashing for a defined period of time. However, this is associated with a large operating effort for identifying a larger number of devices in a system.

### SUMMARY

In an embodiment, the present invention provides a central controller for a data network. The central controller includes an input interface for receiving a request signal, a control unit for generating a control signal depending on the request signal received, and at least one output interface for transmitting the control signal to at least one participant device. The control signal is set up to actuate the at least one participant device to emit a participant output signal for identifying a physical position of the at least one participant device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an exemplary embodiment of the system with a central controller; and

FIG. 2 illustrates an exemplary embodiment of a method with a central controller.

### DETAILED DESCRIPTION

Embodiments of the present invention provide a central controller and a system for a data network, as well as a method for operating such a central controller, which allow a particularly simple and efficient operation.

The central controller for a data network comprises an input interface for receiving a request signal, a control unit for generating a control signal depending on the request signal received and at least one output interface for transmitting the control signal to at least one participant device. The participant device is linked, in particular in relation to data, to the output interface of the central controller. The control signal is set up to actuate the participant device to emit a participant output signal for identifying a physical position of the participant device.

The participant device can thereby advantageously be found particularly easily. The request to emit the output signal can in addition be evaluated particularly efficiently.

In one design, the input interface is set up to receive the request signal by means of a first data protocol, in particular by means of ethernet, single pair ethernet (SPE), fieldbus, PROFIBUS or another bus protocol. Furthermore, the output interface is set up to transmit the control signal by means of a second data protocol, for instance by means of IO-Link, AS-Interface, HART protocol or another protocol for sensor-actuator communication. The first and second data protocols are formed different from each other. For example, the central controller can be connected to a bus system and configured as an IO-Link master, wherein the participant devices are configured as IO-Link devices and assigned to the IO-Link master.

The actuation is thereby advantageously effected in a multi-protocol manner:

The first data protocol is used to address the central controller and to transmit the request signal. This part of the actuation is effected for example by an external device which is coupled, in relation to data, to the central controller, for instance via a bus system. The external device can have for example an operating interface, for instance an interface for programming and/or for eliminating errors or technical problems within the data network.

The second data protocol is then used to transmit the request for the emission of the participant output signal from the central controller to the participant devices linked to it. As the second protocol differs from the first, this actuation cannot be effected directly, for instance from the external device, but rather the central controller undertakes, in an intermediate step, the transfer, for instance within an IO-Link system. The central controller can optionally carry out a modification of the request, with the result that the participant output signal emitted can be configured in a particularly easy and user-friendly manner.

The central controller thus mediates in the actuation between the layers of the first and second data protocols. It is not necessary for the user to configure this behaviour of the central controller and the connected participant devices individually. Instead, the emission can be distributed within an entire partial system through a simple command to the central controller.

The output signal can be formed in various ways. In particular, it is suitable for enabling a human user to find the respective device. In particular, the user can pinpoint in a room the device from which the output signal is being emitted.

In a further design, the participant output signal is formed sensorily detectable for a user. In particular, the output signal is detectable for human hearing or vision.

Operation is thereby advantageously designed very simply and the user can physically pinpoint the device without additional equipment. In contrast to known systems, no further device is necessary to detect the output signal.

Various modalities can be used for the emission of the participant output signal. These modalities are in particular defined by the units for emitting the output signal, for instance for an acoustically or visually perceptible emission, for example by means of a display, a light-emitting element or a speaker.

Various participant devices can emit the participant output signals by means of different emission modalities, for instance depending on what types of output units are available: for example, a participant device with a display can emit the participant output signal by means of the display, whereas other participant devices without a display, for example, emit participant output signals by flashing of light-emitting elements. Combinations of different modalities of the emission can also be conceivable.

In particular, it can be provided that the control signal does not specify a specific emission modality for the emission of the participant output signal or central controller output signal, but rather that the device itself determines the modalities by means of which the respective output signal is emitted. Furthermore, it can be provided that the request signal and/or the control signal comprises an item of information about a preferred modality or an instruction for a particular modality for the output signal.

In a development, the participant output signal comprises a light signal with a light parameter and/or a graphic and/or alphanumeric indication on a display of the participant device.

It is thereby advantageously particularly easy and clear to pinpoint the device in its surroundings, even in adverse conditions such as poor illumination, which for example makes lettering difficult to detect.

The light parameter can for example relate to a colour and/or brightness; in particular, such a light signal can be emittable by means of a light-emitting element such as for instance an LED, but display elements which are backlit or illuminated in another way can also be used.

The light parameter of a light signal can be settable, for instance through a configuration which is carried out on the participant device or on the central controller, or through a corresponding item of information which is comprised by the control signal.

The light signal can have a particular duration, after the expiry of which its emission is automatically ended, or the light signal can be ended depending on an input by a user or a further control signal. The light parameter can be generated statically or dynamically, in particular a periodic change in the brightness and/or colour can be provided, for instance in the manner of a flashing.

A display which is comprised by the participant device or is arranged in its physical surroundings can be formed in different ways. For example, the display can comprise an array of pixels, with the result that practically any character is emittable, or it can comprise a segment display, wherein the segments predefine the characters that can be displayed.

In a design, the central controller furthermore has an output unit. The output unit of the central controller is set up to emit a central controller output signal for identifying a physical position of the central controller depending on the control signal.

The central controller can thereby advantageously also be pinpointed easily.

In particular, the central controller output signal is formed distinguishable from the participant output signal.

Furthermore, the central controller output signal can be formed perceptible for a user, in particular visually or acoustically.

In particular, the central controller output signal can be formed analogous to the participant output signal and have the features described in the present case.

In a further design, the central controller can furthermore be linked, in relation to data, to a plurality of participant devices. The control unit is formed furthermore to generate the control signal depending on the request signal received such that all participant devices linked to the central controller or a defined subset thereof are actuated to emit participant output signals. The participant output signals of the various participant devices can be formed identically or individually different.

If only a subset of the connected participant devices is to be actuated for the emission, then the definition of the subset can be effected for example by the request signal. Furthermore, a configuration of the central controller can be effected, for instance by a user input, in order to define the subset. For example, a particular address range in a data network can be defined as a sub set.

In a development, the output interface comprises a plurality of output connections. One output connection is allocated to each linked participant device. In particular, a unique allocation between the participant device and an output connection is provided. Furthermore, in the development, the control signal is set up such that the participant output signals emitted by the participant devices are furthermore formed depending on the allocated output connection.

In particular, the participant output signal of a participant device can be formed such that it is to be uniquely allocated to a particular output connection of the central controller.

This advantageously makes it easier to find the physical position of a participant device which is linked, in relation to data, to the central controller in a particular way. This makes it easier for example to search for errors in a system.

The output connections of the central controller can for example be “ports”, such as are known per se from information technology. They can represent physical or virtual connections of the central controller, for instance individual link elements for connecting data cables for the participant devices and/or connections provided in relation to data for participant devices via a common cable connection and/or connections provided in relation to data for participant devices via a wireless link element, for example via radio, WLAN, Bluetooth or other methods.

For example, the participant output signals are therefore formed such that they comprise a sensorily detectable item of information about the respectively allocated output connection. The user can thereby detect, for instance visually, the output connection via which a participant device is linked to the central controller.

For example, each linked participant device can emit a beep signal or flashing signal, wherein a particular number of beeps or flashes are emitted periodically, separated by pauses. The number of beeps or flashes per period can then be allocated to a number allocated to the output connection, for example a numbering of the output connections, for instance a consecutive numbering.

If a linked participant device emits the participant output signal by means of a display, then alphanumeric characters or graphic elements can also be used to identify the allocated output connection of the central controller.

Furthermore, it can be provided that, together with the output signal of a participant device, a further output is thus emitted to the central controller, whereby the respective output connection can be detected or physically pinpointed. For example, a light source at a connection can flash or emit another light signal in order to indicate that a particular participant device is connected with this connection. For example, identically formed light signals are emitted both at the output connection and at the participant device.

Embodiments of the system for a data network comprise a central controller according to the present description and at least one participant device which is coupled, in relation to data, to the central controller. The participant device comprises an output unit for emitting an output signal for identifying a physical position of the participant device. Optionally, the output signal can be formed visually or acoustically perceptible.

In the method for operating a central controller in a data network, at least one participant device is allocated, in relation to data, to the central controller. A request signal is received and a control signal is generated depending on the request signal received. The control signal is set up to actuate the participant device to emit a participant output signal for identifying a physical position of the participant device.

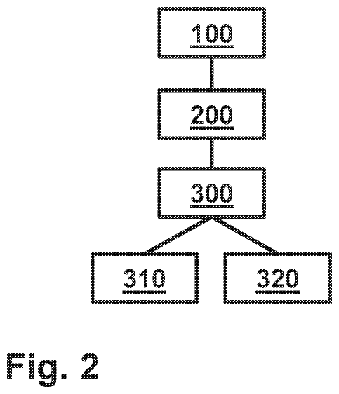

The method, such as the example method of FIG. 2, is in particular formed to operate the device. It therefore has at least the same advantages as the device.

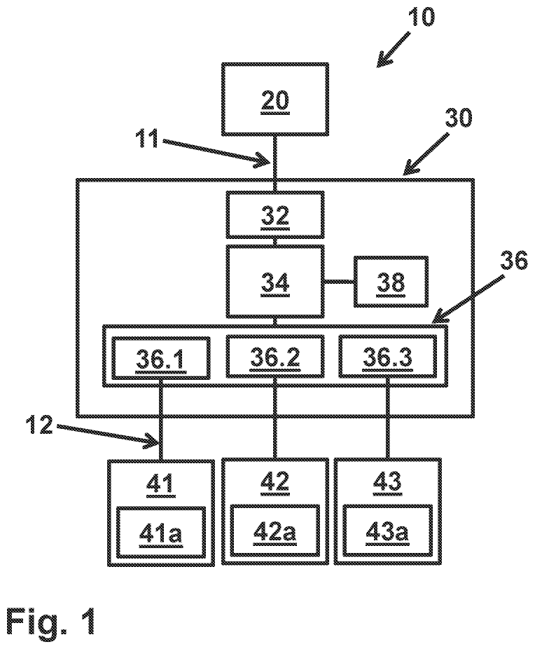

An embodiment example of the system with the central controller is explained with reference to FIG. 1.

The system 10 comprises a central controller 30, an external device 20 and several participant devices 41, 42, 43.

In the example, the external device 20 and the central controller 30 are linked, in relation to data, to each other via an ethernet link 11 in a manner known per se.

In further embodiment examples, other methods for the data link can be used, for instance Single Pair Ethernet (SPE) or bus links such as fieldbus, for example PROFIBUS.

Furthermore, the participant devices 41, 42, 43 are linked to the central controller 30 in a manner known per se by means of IO-Links 12.

In further embodiment examples, other methods for the data link can be used, for instance HART or AS-Interface protocols.

In the system 10 of the example, the external device 20 can address the central controller 30 via a first protocol, namely ethernet, whereas it can address the participant devices 41, 42, 43 via a second protocol, namely IO-Link. A direct addressing of the participant devices 41, 42, 43 cannot be effected from the external device 20, as a “protocol boundary” must be overcome.

The central controller 30 comprises an input interface 32, by means of which the data link to the external device 20 is established.

The central controller 30 furthermore comprises an output interface 36, which for its part comprises output connections 36.1, 36.2, 36.3. The participant devices 41, 42, 43 are connected to this output interface 36, wherein one output connection 36.1, 36.2, 36.3 is uniquely allocated to each connected participant device 41, 42, 43.

The central controller 30 furthermore comprises a control unit 34, which is coupled to the input interface 32 and the output interface 36.

Furthermore, an output unit 38, coupled to the control unit 34, of the central controller 30 is provided, which comprises an LED in the example.

Starting from the above-explained embodiment example of the system, an embodiment example of the method is explained below with reference to FIG. 2.

In a step 100 the external device 20 generates a request signal, which is transmitted to the central controller 30 via the data link 11. In the example, the input interface 32 of the central controller 30 is used for this.

In the example, an ethernet protocol is used, but another protocol can be used, such as single pair ethernet (SPE), PROFIBUS, fieldbus or another comparable protocol.

In a step 200 the request signal received by the interface 32 is transferred to the control unit 34 of the central controller 30 and evaluated there. The control unit 34 is set up to generate one control signal or several control signals depending on the request signal received, in order to actuate further units.

In the present exemplary case, the control signal is formed such that with it the output unit 38 of the central controller as well as the connected participant devices 41, 42, 43 with the output units 41a, 42a, 43a are actuated.

In a step 300 the control signal is emitted by the control unit 34.

In the case of this emission of the control signal, in a step 310 in the embodiment example of the method the output unit 38 of the central controller 30 is actuated directly. This output unit 38 is formed as an LED 38, which flashes in response to the control signal in a defined manner.

In parallel to this, in a step 320 the connected participant devices 41, 42, 43 are actuated via the output interface 36 and the data link 12. In the embodiment example this is a link 12 according to the IO-Link standard.

The output units 41a, 42a, 43a, likewise formed as LEDs 41a, 42a, 43a, emit output signals by flashing them in response to the control signal in a defined manner.

The defined flashing of the LEDs 38, 41a, 42a, 43a of the central controller 30 and participant devices 41, 42, 43 in the system 10 has light parameters. These light parameters can be formed identical or different for all devices 30, 41, 42, 43.

In particular, the light parameters comprise for instance brightness, light colour, flashing frequency or number of flashes within a time interval or a period, the duration of individual flashes as well as their gap from each other and the duration of dark phases between the flashes. Furthermore, a duration of the emission of the flashing can be predefined as a light parameter, for instance as time-out of the output signal emitted.

In the embodiment example, it is provided that the light parameters are formed individually for each output unit of the central controller 30 and the participant devices 41, 42, 43 and are predefined by the control unit 34 of the central controller 30. The participant output signals of the participant devices 41, 42, 43 are formed such that they comprise an item of information about the respective port or output connection 36.1, 36.2, 36.3, in which the participant device 41, 42, 43 is connected to the output interface 36 of the central controller 30.

For example, the output connections 36.1, 36.2, 36.3 can be numbered and the output signal of each of the participant devices 41, 42, 43 can emit the number allocated to an output connection 36.1, 36.2, 36.3 by means of a flashing signal. For example, the output signal for a first participant unit 41 can comprise a single flash in order to indicate that it is connected to the first output connection 36.1 of the output interface 36 of the central controller 30.

In a further embodiment example, the output interface 36 of the central controller can furthermore be allocated a further output unit, by means of which an output connection 36.1, 36.2, 36.3 is highlighted depending on the control signal, with the result that for instance a user can identify an output connection 36.1, 36.2, 36.3 to which a particular participant device 41, 42, 43 is linked in relation to data.

In a further embodiment example, it is provided that at least one light parameter is formed for the output signal by each of the devices 30, 41, 42, 43 itself. This means that the output signal is not predefined for all devices 30, 41, 42, 43 with all light parameters by the control unit 34 of the central controller 30, but rather the central controller and the participant devices can determine the output signal for example depending on the available output units 38, 41a, 42a, 43a. For example, in this case, a flashing can be emitted as output signal, if the output unit 38, 41a, 42a, 43a comprises a light source, for instance an LED. The output signal can furthermore comprise alphanumeric characters, if the output unit 38, 41a, 42a, 43a comprises a display suitable for the corresponding emission. Furthermore, the participant devices 41, 42, 43 can independently recognize the port or output connection 36.1, 36.2, 36.3 of the central controller 30 to which they are linked in relation to data, and they can form the output signal accordingly, with the result that the latter comprises an item of information for identifying the respectively connected port or output connection 36.1, 36.2, 36.3. For example, the output signal comprises a flashing with a number of periodically repeated flashes, wherein the number of flashes corresponds to a number of the connected port or output connection 36.1, 36.2, 36.3.

Analogously to the flashing, other types of output signals can be emitted, for instance other visually or acoustically perceptible signals which are emittable by the output units 38, 41a, 42a, 43a. These output signals can also be formed identical or different for all devices 30, 41, 42, 43, and they can be predefined by the control unit 34 or be formed by the devices 30, 41, 42, 43 themselves, for instance depending on the available output units 38, 41a, 42a, 43a.

In a further embodiment example, the output units 38, 41a, 42a, 43a of the central controller 30 or participant devices 41, 42, 43 can comprise a display, by means of which light signals and/or alphanumeric characters are emittable. The control signal can in this case be formed to actuate the output units 38, 41a, 42a, 43a such that, by means of the display, the output signal is emitted such that the physical position of the respective central controller 30 and/or participant device 41, 42, 43 can be determined and/or that a further item of information about the data link between the central controller 30 and a connected participant device 41, 42, 43 is emitted, for instance the physical or virtual output connection 36.1, 36.2, 36.3 or port of the output interface 36 used for the connection, or the physical position of a physical output connection 36.1, 36.2, 36.3 used.

In a further embodiment example, in addition to an output signal for identifying a physical position of the central controller 30 or participant device 41, 42, 43, diagnostic data can be emitted by means of such a display or in another manner known per se, in particular relating to the functioning and/or quality of the data link 12.

In a further design, the request signal comprises an item of information about at least one output parameter, for instance a light parameter. The control signal is generated such that the output signal emitted, for instance a light signal, is generated with properties corresponding to the request signal. For example, by means of the request signal, it is possible to define the colour in which the central controller 30 and/or the participant devices 41, 42, 43 generate a light signal and flash, for example.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

10 system
11 ethernet link
12 IO-Link
20 external device
30 central controller; IO-Link master
32 input interface; ethernet interface
34 control unit
36 output interface; IO-Link interface
36.1, 36.2, 36.3 output connection; port (of the IO-Link interface)
38 output unit; LED
41, 42, 43 participant device, IO-Link device
41a, 42a, 43a output unit; LED
100, 200, 300, 310, 320 step

1. A central controller for a data network, comprising:
an input interface for receiving a request signal;
a control unit for generating a control signal depending on the request signal received; and
at least one output interface for transmitting the control signal to at least one participant device; wherein
the control signal is set up to actuate the at least one participant device to emit a participant output signal for identifying a physical position of the at least one participant device.

2. The central controller according to claim 1, wherein
the input interface is set up to receive the request signal through a first data protocol;
the output interface is set up to transmit the control signal through a second data protocol; and
the first and second data protocols are formed different from each other.

3. The central controller according to claim 1, wherein the participant output signal is formed to be detectable by the senses of a user.

4. The central controller according to claim 1, wherein the participant output signal comprises a light signal with a light parameter or a graphic indication on a display of the participant device.

5. The central controller according to claim 1, wherein the central controller further comprises an output unit, and
the output unit of the central controller is set up to emit a central controller output signal for identifying a physical position of the central controller depending on the control signal.

6. The central controller according to claim 1, wherein the central controller is linked, in relation to data, to a plurality of participant devices, and
the control unit is formed to generate the control signal depending on the request signal received such that each of the plurality of participant devices linked to the central controller are actuated to emit the participant output signals.

7. The central controller according to claim 6, wherein the output interface comprises a plurality of output connections,
each of the plurality of output connections is uniquely allocated to each of the plurality of linked participant devices; and
the control signal is set up such that the participant output signal emitted by each of the plurality of the participant devices are formed depending on the uniquely allocated plurality of output connections.

8. A system for a data network, comprising:
an input interface for receiving a request signal;
a control unit for generating a control signal depending on the request signal received; and
at least one output interface for transmitting the control signal to at least one participant device, wherein
the control signal is set up to actuate the at least one participant device to emit a participant output signal for identifying a physical position of the at least one participant device;
the at least one participant device is coupled, in relation to data, to the central controller; and
the at least one participant device comprises an output unit for emitting the participant output signal for identifying the physical position of the at least one participant device.

9. A method for operating a central controller in a data network with at least one participant device allocated, in relation to data, to the central controller, comprising:
receiving a request signal; and
generating a control signal depending on the request signal received, the control signal being set up to actuate the at least one participant device to emit a participant output signal for identifying a physical position of the at least one participant device.

10. The central controller according to claim 2, wherein the first data protocol is ethernet, single pair ethernet (SPE), fieldbus, PROFIBUS or another bus protocol.

11. The central controller according to claim 2, wherein the second data protocol is IO-Link, AS-Interface, HART protocol or another protocol for sensor-actuator communication.

12. The central controller according to claim 5, wherein the central controller output signal is formed to be perceptible by a human user.

13. The central controller according to claim 12, wherein the central controller output signal is formed to be visually or acoustically perceptible by the human user.

14. The central controller according to claim 1, wherein the central controller is linked, in relation to data, to a plurality of participant devices, wherein
the control unit is formed to generate the control signal depending on the request signal received such that a defined subset of the plurality of participant devices are actuated to emit participant output signals.

15. The system for a data network according to claim 8, wherein the output signal is formed to be visually or acoustically perceptible.
